(19) United States
(12) Patent Application Publication
(10) Pub. No.: US 2007/0276734 A1
(43) Pub. Date: Nov. 29, 2007

(54) METHOD AND SYSTEM OF ADVERTISING

(76) Inventor: Earl Littman, Houston, TX (US)

Correspondence Address: KEELING PATENTS AND TRADEMARKS, 3310 KATY FREEWAY, SUITE 100, HOUSTON, TX, 77007, US

(21) Appl. No.: 11/837,592

(22) Filed: Aug. 13, 2007

Related U.S. Application Data
(63) Continuation-in-part of application No. 10/616,000, filed on Jul. 9, 2003.
(60) Provisional application No. 60/429,225, filed on Nov. 26, 2002.

(51) Int. Cl. G06Q 30/00

(52) U.S. Cl. 705/14

(57) ABSTRACT

A method and related system for advertising that senses the presence of a consumer proximate to a display of products, invokes (based on the presence of the consumer), an advertisement selected from a group of previously supplied advertisements, and wirelessly reports statistics of the invocation of advertisements. A second method related to inventory control of a product wherein an identification tag having a wireless communication device is attached to a product, the identification tag is read with a corresponding reader having a wireless communication device communicable with said identification tag, product-related information obtained from the identification tag is processed, the presence of a consumer is sensed, and at least one consumer is informed of commercial information associated with the product-related information. This method may further encompass the initiation of a discount associated with pre-selected products.

### CROSS-REFERENCE TO RELATED APPLICATIONS

This application is a continuation-in-part of U.S. non-provisional application Ser. No. 10/616,000, filed on Jul. 9, 2003, which claims the benefit of U.S. provisional application Ser. No. 60/429,225, filed on Nov. 26, 2002.

### STATEMENT REGARDING FEDERALLY SPONSORED RESEARCH OR DEVELOPMENT

Not Applicable.

### BACKGROUND OF THE INVENTION

1. Field of the Invention

The preferred embodiments of the present invention are directed to a method and system of advertising. More particularly, various embodiments of the invention may be directed to displaying previously and wirelessly dynamically supplied advertisements triggered by a detected presence of a consumer, and reporting statistics of the advertising play.

2. Background of the Invention

Advertising has become pervasive in today's society. Traditional advertising methods include television, radio, and publications, while more recent methods include internet-based advertisements. Regardless of the method employed, businesses utilize advertising to introduce consumers to their products and to encourage consumers to purchase their products.

Because a consumer might not purchase the product for days or even months after hearing or seeing an advertisement, most advertising methods, such as television, rely on innovative and creative advertisements that consumers will remember when making the purchase. Other methods for encouraging consumers to purchase a certain product include product demonstrations (e.g., prerecorded advertisements and in-person demonstrations) located close to the actual point of purchase. For example, short product demonstrations and advertisements are sometimes prerecorded on a video and then played in a location proximate to where the products (consumer products) are sold. While prerecorded video and in-person product demonstrations may escalate product sales, they have certain drawbacks, e.g. labor costs associated with in-person demonstrations. Although labor costs may be avoided by using a prerecorded video, the video may require manual and periodic intervention. Accordingly, there is a need for a method of advertising at the point of sale that may overcome the disadvantages of existing advertising methods.

### BRIEF SUMMARY OF THE INVENTION

The problems noted above are solved in large part by a method and related system for displaying advertisements. One aspect of the embodiments of the invention may be a method comprising: sensing presence of a consumer proximate to a display of consumer products, invoking (based on the presence of the consumer) an advertisement directed to at least one sense of the consumer, and reporting statistics of invocation of advertisements. Detecting presence of the consumer may comprise ultrasonically detecting the consumer or movement of inanimate objects caused by the consumer, detecting electric and/or electromagnetic field changes associated with the presence of the consumer, optically detecting the presence of the consumer, and/or detecting a radio frequency identification device carried by the consumer. The advertisement directed to the sense of the consumer may comprise an audio clip, a video clip, an audio/visual presentation, the release of a chemical to appeal to the consumer's sense of smell and the like.

A second aspect of the embodiments of the invention may be an advertising system comprising: a first computer system, and a remote advertising player coupled to the first computer system by way of a communication system, whether connected by wiring, wirelessly or by a combination thereof. The remote advertising player may sense the presence of a person, play advertisements stored in the remote advertising player supplied by the first computer system, and report a notice of advertising play to the first computer system. The remote advertising player may further comprise a communication device for reproducing an audio and/or video clip. The communication device may comprise devices such as a video display, an audio speaker and/or the like.

A third aspect of the embodiments of the invention may be a method of inventory control. This method may comprise: attaching an identification tag having a wireless communication device to a product, reading the identification tag with a corresponding reader having a wireless communication device communicable with said identification tag, processing product-related information obtained from the identification tag, sensing the presence of a consumer, and informing at least one consumer of commercial information associated with the product-related information. This method may further encompass the initiation of a discount associated with pre-selected products.

Another aspect of the embodiments of the invention includes providing wireless communication between or among one or more of the first computer system, the remote advertising player and a remote computer system.

Another aspect of the embodiments of the invention may comprise an additional step of providing an electronic coupon for use with the purchase of the corresponding product.

Yet another aspect of the embodiments of the invention may comprise a system having: a processor, a random access memory (RAM) coupled to the processor, a communication device coupled to the processor, a sensing device coupled to the processor, and an advertisement reproduction device coupled to the processor. The system may receive advertisements by way of wireless technology, such as cellular technology, Wi-Fi® (Wi-Fi is a registered certification mark of Wireless Ethernet Compatibility Alliance, Inc.), WiMax and the like, and store the advertisements, possibly in the RAM. The processor may be programmed to sense proximity of a consumer using the sensing device, and when the consumer is detected, the processor may play an advertisement stored in the RAM on the advertisement reproduction device. The processor may further report statistics of advertising play to external devices across the communication device. The processor may provide electronic instructions to a secondary system regarding the value and appropriateness of providing an electronic coupon. The advertisement reproduction device may comprise devices such as a video monitor and/or a video monitor having a touch-screen control panel.

The disclosed devices and methods comprise a combination of features and advantages which enable it to overcome the deficiencies of the prior art devices. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates an advertising system constructed in accordance with at least some embodiments of the invention;

FIG. 2 illustrates a store controller constructed in accordance with at least some embodiments of the invention;

FIG. 3 illustrates an advertising player constructed in accordance with at least some embodiments of the invention;

FIG. 4 illustrates an advertising system that functions without the use of a store controller; and

FIG. 5 illustrates the advertising players ability to communicate with the establishment's central computer and/or the point of sale devices to transfer information.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION OF THE PREFERRED EMBODIMENTS

At least some of the embodiments of the invention were developed in the context of displaying advertisements within the freezer section of a grocery store, possibly triggered by opening of a door on a freezer compartment. The following specification is, therefore, related to the developmental context; however, describing the various embodiments of the invention in relation to the developmental context should not be construed as a limitation as to the breadth and applicability of the invention. The methods and systems described herein may find applicability in other advertising situations.

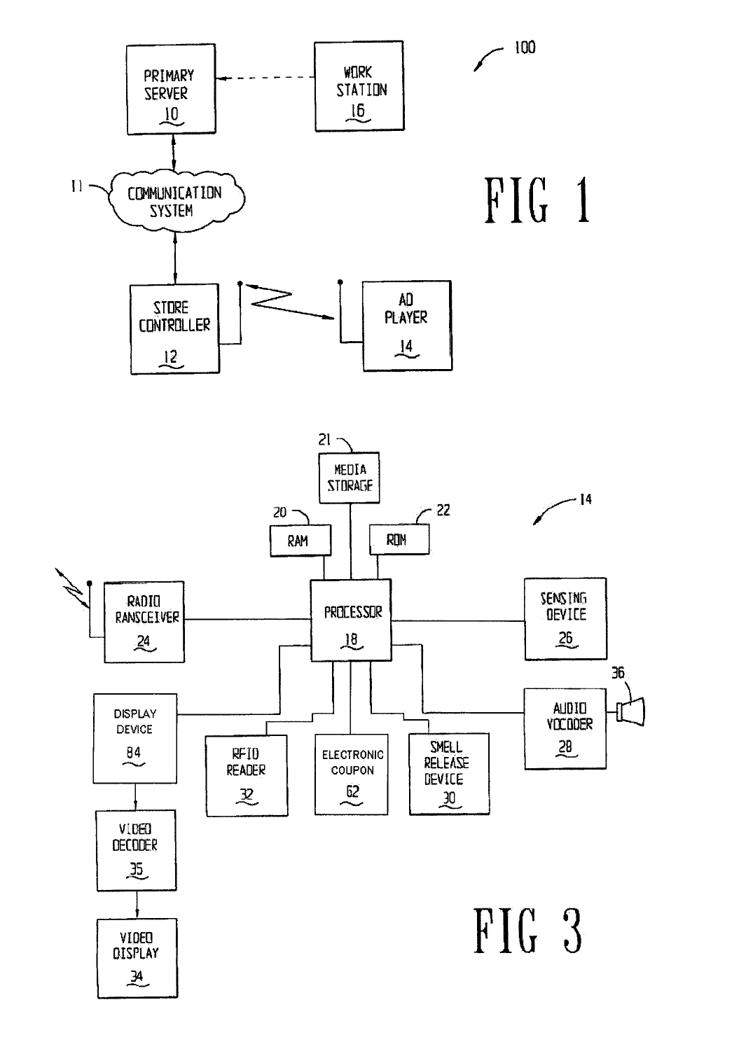

FIG. 1 illustrates an advertising system 100 constructed in accordance with at least some embodiments of the invention. The advertising system 100 may comprise a primary server 10. The primary server 10 may be a single computer system, or an array of computer systems coupled together to form a network. The primary server or servers 10 may be any available computer system, such as may be available from vendors like Hewlett-Packard and Dell. The primary server 10 may be a Windows® or Unix® based system or other suitable commercially-available server. The primary server 10 may couple to a store controller 12 by way of a communication system 11. The communication system 11 may comprise any suitable communication system, such as the Internet, dedicated telephone line connections, across power lines, the utilization of cellular technology, Wi-Fi®, WiMax, satellite communications or other suitable commercially-available wireless communication systems. The store controller 12 may likewise be a computer system, though in some embodiments the store controller 12 may not require the degree of computing capability that may be present in primary server 10.

In at least some embodiments of the invention the store controller 12 may be located remote from the primary server 10, possibly in a retail store of any variety. In the exemplary case of utilizing the embodiments of the invention in a grocery store, the store controller 12 may be placed at an inconspicuous location within the grocery store. The store controller 12 communicates, possibly wirelessly, with one or more advertising players 14 within the general vicinity of the store controller 12. In the exemplary case of a grocery store, a single store controller 12 may be in communication with a plurality of advertising players 14 at various locations throughout the store.

Still referring to FIG. 1, the advertising system 100 may also comprise a work station 16 coupled to the primary server 10. The work station 16 may be used to generate advertisements in various audio and video formats. Once created, the advertisements may be stored in the primary server 10. The work station 16 may be any available computer system, using any suitable operating system, capable of creating and/or editing audio and video content. In alternative embodiments, the work station 16 may not be present, with advertisements being supplied from other sources.

While the exemplary system illustrated in FIG. 1 shows only one store controller 12 coupled to the primary server 10, the primary server 10 may communicate with a plurality of store controllers 12, with one or more store controllers 12 possibly placed in each retail store. Likewise, though FIG. 1 shows only one advertising player 14 wirelessly coupled to store controller 12, each designated area controlled by a store controller 12 may comprise a plurality of advertising players 14.

Further, in an embodiment contemplated by the present invention, a plurality of advertising players 14 positioned at various locations throughout a store may be in continuous contact with at least one other advertising player 14, such as through the use of an internal network or the like.

In accordance with embodiments of the invention, server 10 may maintain a repository of advertisements. Each advertisement may be assigned a unique identifier. For example, the identifier may be a 4-byte identifier, thus allowing approximately 2.5 billion unique identifiers. Using server 10, advertisements may be converted from their source format (e.g., JPEG, .WAV, .MP3, etc.) to a desired file format, and stored into files in a database within the server 10.

Server 10 may also manage advertiser records including organizing current and future advertisements. Managing advertiser records may include maintaining a database of stores and remote playing devices in those stores, and tracking the status of advertising players 14.

Server 10 may also be responsible for downloading advertisements to the advertising players 14, and maintaining a database of advertisements residing at the advertising players 14. In one embodiment, an advertising player 14 may have multiple media slots to which the server 10 sends the advertisement. A media slot may be a portion of memory within the advertising player within which an advertisement may be stored. The advertising player 14 may, for example, play the advertisements contained in a plurality of media slots sequentially, or the advertising player 14 may randomly select from the various advertisements stored in the media slots. Advertisements may be downloaded to a single advertising player 14 or a group of advertising players 14. The server 10 may query advertising players 14 to determine statistics or a metric of advertising play. If an advertising player 14 acknowledges that a particular advertisement was successfully played, then the server 10 may signal the advertising player 14 to delete the record from its storage, and transfer a new advertisement.

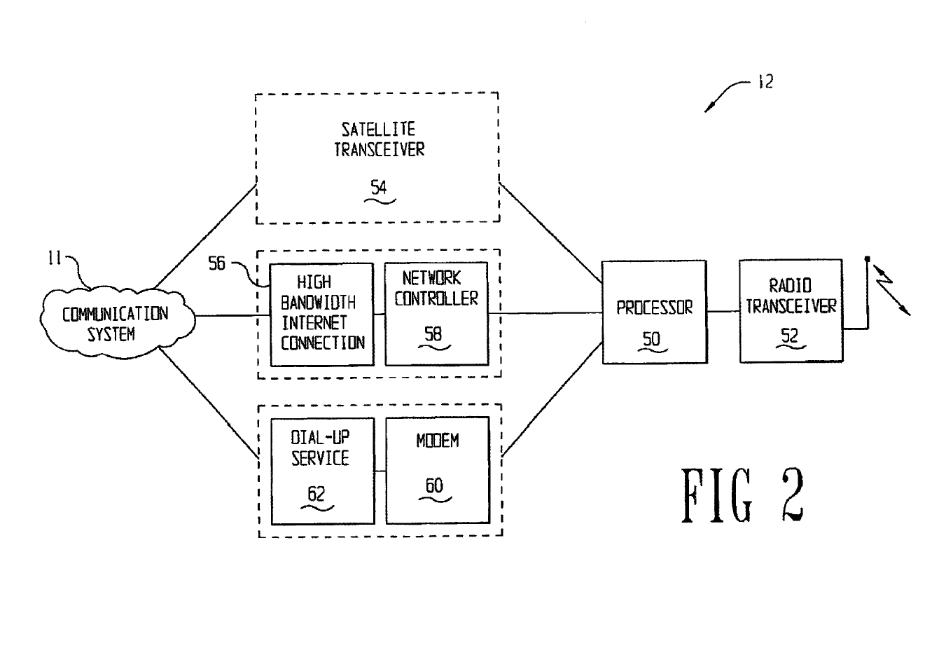

The store controller 12 may manage communication between the server 10 and the one or more advertising players 14 for which it is responsible. FIG. 2 illustrates a store controller 12 constructed in accordance with at least some embodiments of the invention. The store controller 12 may comprise a processor 50 which may be any suitable microprocessor or microcontroller, but in at least some embodiments the processor 50 may be a microcontroller produced by Microchip having a part number 18F452, or an Atmel Corporation part number ATmega128. The processor 50 may couple to a radio transceiver 52. The radio transceiver 52 may be responsible for communicating with the one or more advertising players 14 in the region of the store controller 12. In at least some embodiments of the invention, the radio transceiver 52 may operate at 900 MHz, such as devices produced by MaxStream, Inc. of Orem, Utah, and Xemics USA Inc. of Mountain View, Calif. FIG. 2 also illustrates three possible systems to couple the store transceiver 12 to the communication system 11, though others may be possible. Thus, in some embodiments of the invention the store controller 12 may couple to the communication system 11 by way of a satellite transceiver 54. Many retail stores, such as grocery stores and possibly smaller convenience stores, operate their own dedicated satellite network. In these circumstances, the primary server 10 may be located at a central facility and may communicate with one or more store controllers 12 over a satellite system. In this exemplary case, the communication system 11 may thus be a satellite-based communication system. In alternative embodiments of the invention, the communication system 11 may be the Internet, and thus the store controller 12 may couple to the communication system 11 by way of a high bandwidth Internet connection 56, such as a digital subscriber line connection or possibly by way of a cable modem. In these circumstances, the processor 50 may communicate with the cable modem or DSL controller by way of a network controller 58. Though high bandwidth (and therefore higher speed) Internet connections may be desirable, various embodiments of the invention may still be operable even if the store controller 12 couples to the communication system 11 being Internet by way of a modem 60 and dial-up service 62. In accordance with at least some embodiments of the invention, communications between the controller 12 and the server 10 may use a TCP/IP connection across the communication system 11. The controller 12 may communicate with one or more advertising players 14 over a radio transceiver 52. Because the communication between the store controller 12 and the one or more advertising players 14 may be slower than the speed at which the store controller 12 communicates to the primary server 10 over the communication system 11, the store controller 12 may perform buffering and spooling of the information to prevent data loss. For example, the wireless connection to each advertising player 14 may operate at 19,200 baud, whereas an exemplary DSL Internet connection may operate at 1 Mbit, and an exemplary dial-up connection may operate at 56,000 baud. The store controller 12 may periodically (e.g. approximately once each hour) test the wireless connection for the advertising player 14. Faulty advertising players 14 may be reported to the server 10.

Although controllers 12 may have unique addresses, most of the information from the servers 10 is bound for the advertising players 14. For example, an advertisement from server 10 to advertising players 14 may be received by the controller 12 via TCP/IP, and then relayed over a wireless connection. The wireless connections disclosed herein may be any one of various wireless standards, such as 900 MHz, 2.4 GHz, IEEE 802.11b, Bluetooth, and the like.

FIG. 3 illustrates an advertising player 14 constructed in accordance with at least some embodiments of the invention. An advertising player 14 may thus comprise a processor 18, which may be a microcontroller produced by Microchip having a part number 18F452, or a Atmel Corporation part number ATmega128. While a microcontroller generally may have on-board random access memory (RAM) and read-only memory (ROM), additional RAM 20 and ROM 22 may be coupled to the processor 18. In alternative embodiments of the invention, the processor 18 may be an individual microprocessor together with a chipset and external RAM 20 and ROM 22 to perform the computing functionality.

In order that the advertising player 14 may communicate with the store controller 12 and/or the primary server 10, a radio transceiver 24 may be coupled to the processor 18. The radio transceiver 24 may thus be responsible for forming at least part of the communication link between the advertisement player 14 and the primary server 10. The radio transceiver 24 may be a device manufactured by MaxStream having a part number X09-019NSI. In alternative embodiments, a communication system such as a network interface may be used in addition to or in place of the radio transceiver 24. Such a network interface may allow the advertising playing to communicate over a hard-wired connection to the store controller 12, or the advertising player 14 may bypass the store controller 12 and communicate directly to the primary computer.

Referring to FIG. 3 and FIG. 5, an advertising player 14 may include an electronic coupon device 62 coupled to the processor 18. The electronic coupon device 62, through the advertising player 14, may deliver, to the establishment's central computer 42, point of sale device 40 or the like, unique pricing information about each item that is being purchased in order to provide individual discounts to the consumers. This unique pricing information may be varied and/or updated by a remote user through the wired or wireless connection.

The present invention contemplates an embodiment wherein the advertising player's 14 computer system or server communicates independently with the point of sale devices 40. In such embodiment, the advertising player 14 may, wired or wirelessly, transmit the electronic coupon 62 discount information to the establishment's point of sale devices 40 in order to effectuate the discounting of the chosen item or items. The store controllers 14 may further communicate with each other within an establishment in order to synchronize the advertising play, produce a total amount discounted for a certain time frame or within a certain department of the establishment, or the like.

The electronic coupon device 62 may couple with a sensing device 26 or some similar commercially-available device in sensing when an item has been selected for purchase. Upon this notification, an electronic coupon may be delivered to the establishment's central computer 42, point of sale device 40 or the like in order to effectuate the discount once the selected item is purchased by the consumer. In an alternative embodiment, the electronic coupon 62 may be wirelessly transmitted to a device or card located on the user wherein that device or card may be used at checkout to recall the discount information. In a further alternative embodiment, the advertising player 14 may print a paper coupon for use by the consumer.

An advertising player 14 may also comprise a sensing device 26 coupled to the processor 18. As will be discussed more fully below, the sensing device 26, in its many possible forms, may be responsible for detecting the presence of a consumer proximate to the advertising player 14 and/or a product display with which a particular advertising player 14 is associated and the sensing device may transmit this data to the advertising player 14. The advertising player 14 may further comprise a display device 84 such as a video display 34 coupled to the processor 18 by way of a video decoder 35, informational screen coupled to the advertising player 14, or a similar commercially-available device. The display device 84 may be the mechanism by which images (whether single images, moving video, or interactive information) may be displayed. The video display 34 of the display device 84 may take many possible forms, such as a cathode ray tube, an active-matrix flat panel display, a liquid crystal (LCD) display and the like. The video display 34 may be a touch screen device wherein a user may interact with the advertising player. This interaction may allow a user to flip through the advertisements in order to view advertisements that the user may be interested in. This interaction may further allow a user to access information concerning consumer products sold in the establishment such as nutritional information, recipe information, safety information, warranty information, frequently asked questions concerning the desired product or the like. In at least some embodiments of the invention, the video display 34 may be a LCD manufactured by L. G. Philips having a part number LB070W02.

The advertising player 14 may also comprise a communication device, such as a speaker 36, coupled to the processor 18 by way of an audio voice encoder (vocoder) 28. The audio vocoder 28 and speaker 36 may play audio advertisements alone, or as accompaniment to the pictures or video images on the display device 84. The audio vocoder 28 may be a device in a chip set available from RC Systems of Everett, Wash., having a part number RC8650. This chip set may also comprise media storage 21, possibly a flash memory, in which digital versions of the advertisements may be stored. The processor 18, in combination with the RAM 20, media storage 21 and/or ROM 22, may store advertisements, possibly provided from the primary server 10 through the store controller 12 for playback. The audio driver 28 may likewise have the capacity to store audio or audio versions of advertisements. Though the video decoder 35 and audio vocoder 28 are shown coupled to the various memory devices (RAM, ROM and media storage) through the processor, each of the video decoder 35 and audio vocoder 28 may be capable of direct memory access, and thus in some embodiments may couple directly to the various memory devices.

For purposes of discussing various embodiments of the invention, consider an advertising system 100 such as that illustrated in FIG. 1. The primary server 10, and possibly work station 16, may be placed at a central location, such as a corporate headquarters for a grocery store chain. A plurality of store controllers 12 may be located at least one each in one or more of the grocery stores owned by the grocery store chain. Within each store, there may be a plurality of advertising players 14 in communication with their store controller 12, and therefore in communication with the primary server 10. Though the following discussion is directed to an exemplary system operating within a grocery store and grocery store chain, this description should not be construed as limiting the use of the methods and systems to just grocery stores. Any retail establishment may utilize the methods and systems discussed herein.

Further consider that one of the advertising players 14 is placed within a freezer having a door. When the advertising player 14 is initially powered up, the primary server 10 may be made aware (or detect) of the presence of the advertising player 14 and thus may transfer a plurality of advertisements, in electronic form, to the media slots of the advertising player 14. The transfer of advertisements in electronic form may comprise the primary server 10 communicating the various files to the store controller 12 over the communication system 11. The store controller 12 may, in turn, forward the files to the advertising player 14, possibly at communication rates different than the communications from the primary server 10. Thus, the store controller 12 may, in some embodiments, act as a buffer and translation device, controlling the speed at which communication may flow between the store controller 12 and the advertising player 14, and possibly also implementing protocols to facilitate the communication. Thus, the advertising player 14 may be provided with a plurality of advertisements to play.

In the exemplary case of the advertising player 14 being placed within a freezer, the sensing device 26 (FIG. 3) may be an ultrasonic sensor monitoring the status of the door. In these exemplary embodiments, when a consumer opens the freezer door, the sensing device 26 may thus signal the processor that a consumer has been detected. In accordance with embodiments of the invention, upon detecting of a consumer, the advertising player 14 selects one of its plurality of advertising messages, and displays that message on one or both of the display device 84 and audio driver. The advertisement may take many forms, such as attempting to influence the purchaser to a particular brand or type of product within the freezer case. Alternatively, the advertisement may provide information relating to the consumer product in proximity to the advertising player 14, such as nutritional information.

After a first user has made a selection and walked away, a second user may approach and open the freezer door. Again, upon detecting the presence of a consumer (in this case by motion of the freezer door), the processor may again invoke playing of an advertising message. While it may be possible for the advertising player 14 to repeat a single message each time a user is detected, preferably the advertising player 14 selects a different advertisement than was played immediately previously. The selection may be a random selection, or some form of round-robin selection scheme. Thus, even if the same consumer opens the exemplary freezer door for a second and possibly a third time, in accordance with embodiments, different advertisements may be triggered.

In some embodiments, an advertising player 14 may communicate with other advertising players in close proximity. Such communication may be for the purpose of coordinating advertising play, or possibly ensuring that advertisements played on one advertising player do not interfere visually or audibly with other advertising players in close proximity.

The advertising player 14 of the various embodiments may also have the capability of tracking various parameters associated with playing a particular advertisement. For example, an advertising player 14 may keep track of a number of times a particular advertisement was played in a given period of time, such as a day. The primary server 10 may periodically poll the advertising player 14 for the statistics or metrics regarding the number of times the stored advertisements have been played. Alternatively, the advertising player 14 may report this information back to the primary server 10. Before proceeding, it should be understood that while the primary server 10 may many times throughout the day deliver advertisements to the advertising players 14, and the advertising players 14 may report statistics or metrics regarding advertising play back to the primary server, the advertising players 14 need not be in communication with the primary server 10 to be operable. For example, if the communication system 11 is inoperable, the advertising players 14 may continue to play advertisements selected from their various media slots, and track their usage. Upon the communication system 11 becoming operable, the statistics may be transferred or different advertisements may be provided.

Though the embodiments above are described in reference to a freezer having a door, this need not necessarily be the case. The advertising player 14 may likewise be placed in operational relationship to a coffin-type freezer, where a consumer reaches through an open top to access the consumer products within. The sensing device 26 may be an ultrasonic sensor, except in this case the sensing device may detect motion of the consumer (as opposed to motion of a door caused by a consumer). Alternatively, in these embodiments the sensing device 26 may be an optically-based device, such as a laser system, in which breaking of a light beam may be the trigger playing an advertisement.

The previous two embodiments were discussed with respect to some kind of refrigerated or freezer case; however, the various embodiments of the invention are not limited to use in connection with refrigerated items. In particular, an advertising player 14 could be placed proximate to a magazine rack, a shelf containing products such as canned goods, a display case, a gas pump, and a stand on which fruit items may be displayed for sale, to name a few. In these exemplary cases, the sensing device 26 may take any suitable form where the presence of the consumer proximate to the advertising player may be detected. Detecting a consumer in these exemplary situations may be done using an ultrasonic sensing device, an optical device, devices that detect local changes electric or electromagnetic field caused by a person's body (such as devices manufactured by Motorola having a part number MC33794). This sensing device 26 data may initiate the play of at least one advertisement by the advertising player 14. Further, the consumer may activate the advertisement directly, such as by pushing a button or standing on a floor mat that contains an electrical switch.

Other methods for detecting presence of a consumer may involve detecting the presence or proximity of a radio frequency identification device (RFID), such as RFID devices available from CopyTag LTD of the United Kingdom, having part number CTTC4 or CRRC1. In these cases, the sensing device 26 may be an RFID reader, such as devices available from CopyTag having a part number CTCR1. If a particular consumer does not already have an RFID device which uniquely identifies the consumer, the retail store within which the advertising player 14 may be located may provide RFID tags to consumers, such as by embedding those tags in preferred customer cards. Regardless of the mechanism by which a consumer is provided an RFID tag, the advertising player 14 may detect the presence of the consumer by reading the RFID tag, and then may provide consumer-specific advertising.

The embodiments discussed to this point have been directed to providing advertising in forms such as video clips and/or audio clips. However, in alternative embodiments advertising players 14 may provide advertisements directed to other senses of the consumer, such as a sense of smell. Referring again to FIG. 3, advertising player 14 may thus comprise a smell release device 30, possibly containing chemicals designed to be smelled by the consumer. Thus, as the advertising sensing device 26 detects the presence of a consumer, a small amount of chemical may be released as a way to interest the consumer in a consumer product related to that smell. As an example only, an advertising player 14 may release small amounts of cologne or perfume in an attempt to interest the consumer in the purchase of these type consumer products. As yet another alternative, an advertising player 14 may release a small amount of chemical that reminds the consumer of the possibility of purchase of a particular food item.

In yet other alternative embodiments of the invention, the advertising player 14 may comprise a RFID reader 32 coupled to the processor 18. The RFID reader 32 may be a device capable of reading RFID tags which may, for example, be placed within the packaging or on the consumer products proximate to the advertising player 14. As these consumer products are removed from the shelf or otherwise relocated, they may pass through the reading beam of the RFID reader 32. Thus, the advertising player 14 may detect which consumer devices that the consumer has removed from the shelf. This information may be reported back to the store controller 12 and/or the primary server 10. In some embodiments, detection of the removal of particular consumer products may itself invoke playing related advertisements. Alternatively, the advertising player 14 may inform the consumer of the price of the product selected, or the RFID reader 32 may trigger the electronic coupon device 62 of the advertising player 14 thereby delivering an electronic coupon for use at checkout. In the case where the sensing device 26 is also an RFID reader 32, the store may track and attribute the purchase by using the data collected by the advertising player 14.

Referring to FIG. 3 and FIG. 5, in an exemplary embodiment, it is possible to control the inventory of an establishment containing consumer products with a limited shelf life. The consumer products are fitted with identification tags, such as RFID tags or other similar commercially-available identification tags containing a wireless communication device embedded therein. The advertising player 14 contains an identification tag reader, such as a RFID reader 32 or other similar commercially-available identification tag readers containing a wireless communication device communicable with the identification tags. The identification tags contain product-related information concerning the particular product they are attached to, such information may include the remaining product shelf life, batch information, source information, and the like. Batch and source information may be helpful in expediting the retrieval of recalled products off of the establishment's shelves.

The advertising player 14 may then play an advertisement directed to a product that is nearing the end of its shelf life and/or further inform the consumer of a predetermined discount on such products. When a consumer selects a product, the identification tag reader reads the identification tag of the product being removed in order to identify whether the product is an item with a soon-to-expire shelf life. If the product is identified as a product that is nearing the end of its shelf life and a discount is available, the advertising player will communicate the electronic coupon 62 to the establishment's central computer 42, point of sale device 40 or the like. The discount amount may be printed from the advertising player 14 for the consumer to take with them for presentation at checkout.

The discount amount may further be wirelessly communicated to a device or card located on the consumer for recall at the checkout, or may be transmitted via another similar commercially-available method. This information regarding what products are nearing the expiration of their shelf life and how many have been purchased as a result of the electronic coupon, along with other relevant information, may be compiled for transmittal to the primary server 10 or the manufacturer's server.

The advertising player 14 may display the discount information on an informational screen. This display on an informational screen may occur together with an advertisement aimed at the discounted product. This display on an informational screen may occur while an advertisement is not playing or while an advertisement for another product is playing. The advertising player 14 may display the discount amount for the electronic coupon 62 while finishing the current advertisement that was originally playing before switching to an advertisement directed to the discounted product.

The identification tag reader 32 may read the consumer products on the shelves for their product-related information. This product-related information may then be processed to determine the relevant commercial information related to the products such as the existence of a discount on the products, an advertisement, nutritional information, recipe information, safety information, warranty information, frequently asked questions concerning the desired product or the like. The information may alternatively be processed to determine products scheduled for recall, replacement, that have passed their shelf life and need to be removed from the shelves, or the like.

The advertising player 14 may store the product-related information for the consumer products that was gathered by the identification tag reader. A subsequent reading by the identification tag reader of the consumer products may be performed in order to update the previous data concerning the product-related information. A comparison may then be performed whereby the previous information is compared to the newly acquired information in order to determine fluctuations in the information. This deviation in information may include consumer products that are nearing their shelf life but were absent from the previous reading. This information may be used to determine whether products are still available for a nearing the end of their shelf life discount. If discounts are still available, the advertising player 14 may then play advertisements aimed at these products and/or the advertising player 14 may inform the consumer about the discounts that are available. The readings may be performed at pre-determined intervals or may be manually initiated at any time either at the advertising player 14 location or from a remote location. This manual reading may be initiated through wireless communication means.

A further communication step may be implemented after the product-related information has been processed to compare the new readings with the previous ones. The absence of product may be communicated to an inventory information system that may be set up on the primary server 10, store controller 12, the establishment's central computer 42, a manufacture's computer system, point of sale device 40, advertising player or similar commercially-available device.

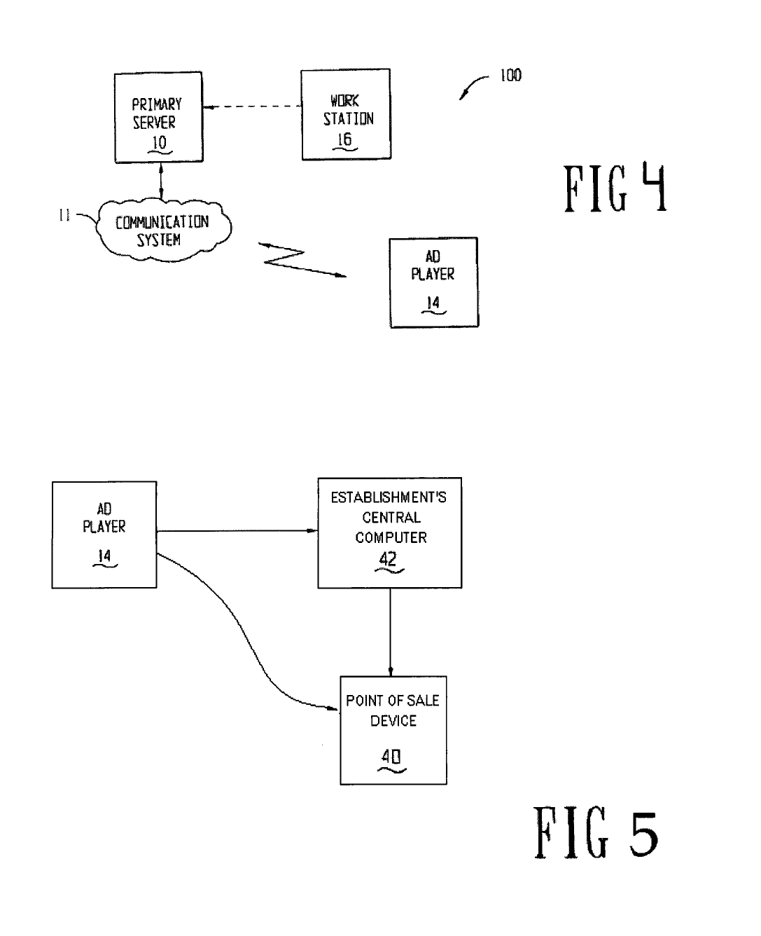

Referring to FIG. 4, in an exemplary embodiment, the use of the store controller 12 may be bypassed completely allowing for the direct communication between the primary server 10 and the advertising players 14 by utilizing a wireless communication system 11. The wireless communication system 11 provides the necessary linkage between the primary server 10 and the advertising players 14. This linkage provides the capability to effect the transfer of information, such as the advertisements, metric data, valuation of electronic coupons or the like between the primary server 10 and the advertising player 14. The wireless communication system 11 may function through the use of wireless technology, including but not limited to Global System for Mobile communications (GSM), Enhanced Data rates for GSM Evolution (EDGE), General Packet Radio Service (GPRS), Enhanced GPRS (EGPRS), Evolution-Data Optimized (EV-DO), Universal Mobil Telecommunications System (UMTS), time division multiple access (TDMA), and/or code division multiple access (CDMA); cellular network; Wi-Fi; Worldwide Interoperability for Microwave Access (WiMax); wireless local area network (WLAN); wireless metropolitan area networks (WMAN); wide area network (WAN); cellular technology, satellite technology; and/or any other commercially-available wireless technology.

Communication between the advertising players 14 within a sole location may be effectuated through these same types of wireless communications along with wireless personal area networks (WPAN), such as Bluetooth® (Bluetooth is a registered certification mark of Bluetooth Sig, Inc.), and the like.

The above discussion is meant to be illustrative of the principles and various embodiments of the present invention. Numerous variations and modifications will become apparent to those skilled in the art once the above disclosure is fully appreciated. For example, it may be possible for the advertising player 14 to communicate to the primary server 10 without the intervention of the store controller 12, such as connecting to an existing internal network. It is intended that the following claims be interpreted to embrace all such variations and modifications.

What is claimed is:

1. A method comprising:
a sensing step comprising sensing presence of a consumer proximate to a display of consumer products;
a publication step comprising publication of an advertisement selected from a group of advertisements, at least one advertisement directed to at least one sense of the consumer;
a detecting step comprising detecting removal of a consumer product from said display of consumer products; and
a communicating step comprising providing an electronic output related to said removed product.

2. The method as in claim 1 wherein said detecting step further comprises reading a radio frequency tag attached to said consumer product.

3. The method as in claim 1 wherein said electronic output comprises electronic communication with at least one point of sale device.

4. The method as in claim 1 wherein said electronic output comprises electronic communication with at least one computer device.

5. The method as in claim 1 wherein said electronic output initiates a coupon.

6. An advertising system comprising:
a first computer system;
an advertising player;
said advertising player having a sensing device and a display device functionally connected thereto;
said advertising player remote from said first computer system;
said advertising player communicating with said first computer system by at least partial wireless communication; and
whereby said advertising player plays at least one advertisement directed to at least one sense of a consumer.

7. The system of claim 6 wherein said at least one advertisement is stored in said advertising player.

8. The system of claim 6 wherein said at least one advertisement is supplied by said first computer system.

9. The system of claim 6 wherein said at least one advertisement is played by said advertising player in response to data from said sensing device.

10. The system of claim 6 wherein said advertising system reports a metric of advertising play to at least one computer system.

11. The system of claim 6 further comprising an audio speaker functionally connected to said advertising player.

12. The system of claim 9 wherein said advertising player communicates with at least one point of sale device wherein said communication initiates a coupon.

13. The system of claim 11 wherein said sensing device comprises at least one device selected from the group of: ultrasonic sensor, laser device, magnetic flux change sensor, and optical sensing device.

14. The system of claim 11 further comprising:
at least one radio frequency identification tag reader;
said at least one radio frequency identification tag reader functionally connected to said advertising player; and
said at least one radio frequency identification tag reader detects at least one radio frequency identification tag.

15. The system of claim 14 wherein said at least one radio frequency identification tag is carried by a consumer.

16. The system of claim 14 wherein said at least one radio frequency identification tag is attached to a consumer product;
said at least one radio frequency identification tag reader scans a group of consumer products and detects when a product within said group of consumer products has been removed.

17. The system of claim 11 wherein said advertising player provides information to a person about consumer products proximate to said advertising player.

18. The system of claim 11 wherein said advertising player provides nutritional information about foods proximate said advertising player.

19. A method of inventory control for a product comprising:
an attaching step comprising attaching an identification tag having a wireless communication device to a consumer product;
a reading step comprising reading the identification tag with a corresponding reader having a wireless communication device communicable with said identification tag;
a processing step comprising processing product-related information obtained from said identification tag;
a sensing step comprising sensing the presence of at least one consumer; and
an informing step comprising informing said at least one consumer of commercial information associated with the product-related information.

20. The method of claim 19 wherein:
said product-related information comprises remaining product shelf-life; and
said commercial information comprises a discount related to the product.

21. The method of claim 20, further comprising:
at least one inquiry step comprising a wireless electronic inquiry for said identification tag; and
a comparison step for determining the absence of said identification tag from at least one prior reading step.

22. The method of claim 21, further comprising a communication step comprising communicating said product absence to an inventory information system.

23. The method of claim 21 wherein said reading step and said inquiry step comprise a common step repeated at determined intervals.

24. The method of claim 20, further comprising:
a product sensing step comprising sensing the removal of at least one product;
an identifying step comprising identifying whether said at least one product qualifies for a discount; and
a communicating step comprising communicating said discount if said at least one product does qualify for said discount.
